(19) United States
(12) Patent Application Publication
(10) Pub. No.: US 2009/0235169 A1
(43) Pub. Date: Sep. 17, 2009

(54) DIGITAL VIDEO RECORD DEVICE WITH TOUCH-PANEL HUMAN MACHINE INTERFACE

(75) Inventor: Kuei-Pi Cheng, Shindian City (TW)

Correspondence Address: APEX JURIS, PLLC, 12733 LAKE CITY WAY NORTHEAST, SEATTLE, WA, 98125, US

(73) Assignee: TOPVISION DISPLAY TECHNOLOGIES, INC., Shindian City (TW)

(21) Appl. No.: 12/171,032

(22) Filed: Jul. 10, 2008

(30) Foreign Application Priority Data
Mar. 15, 2008 (TW) 097208424

(51) Int. Cl. G06F 3/048

(52) U.S. Cl. 715/719

(57) ABSTRACT

A digital video record device with a touch-panel human machine interface includes a touch panel and a digital video record electronic apparatus. The touch panel is disposed in front of the screen of a monitor, electrically connected to the digital video record electronic apparatus, configured to generate touch coordinate signals, and adapted to send the touch coordinate signals to the digital video record electronic apparatus. The digital video record electronic apparatus electrically connects with at least a video camera, processes video signals generated by the video cameras, displays video signal related pictures and a plurality of icons denoting an operating instruction on the monitor, receives the touch coordinate signals from the touch panel, determines whether the touch coordinate signals correspond to a display range of the icons, and executes, upon affirmative determination, an operating instruction corresponding to the determined icon.

### FIELD OF THE INVENTION

The present invention relates to digital video record devices, and more particularly, to a digital video record device with a touch-panel human machine interface.

### BACKGROUND OF THE INVENTION

A conventional digital video record device is equipped with multiple keys for entering operating instructions. The keys are usually disposed on the casing of the conventional digital video record device. In case of an emergency shown on the monitoring screen, the user has to select the correct operating instruction (for example, an operating instruction of video record) while watching both the monitoring screen and the keys simultaneously. From a user's perspective, human machine interfaces of this kind are rather inconvenient.

In view of a lack of ease of use in operating the human machine interface of the conventional digital video record device, the inventor of the present invention proposes a digital video record device with a touch-panel human machine interface with a view to overcoming the aforesaid drawback of the prior art.

### SUMMARY OF THE INVENTION

It is a primary objective of the present invention to provide a digital video record device with a touch-panel human machine interface, so as to issue operating instructions by means of touch coordinate signals from a touch panel, and display icons denoting the operating instructions on the monitor to facilitate operation of issuing the operating instructions.

To achieve the above objective of invention, the present invention provides a digital video record device with a touch-panel human machine interface. The digital video record device with a touch-panel human machine interface comprises a touch panel disposed in front of a screen of a monitor, electrically connected to a digital video record electronic apparatus, configured to generate touch coordinate signals, and adapted to send the touch coordinate signals to the digital video record electronic apparatus. The digital video record electronic apparatus electrically connects with at least a video camera, processes video signals generated by the video cameras, displays video signal related pictures and a plurality of icons denoting operating instructions on the monitor, receives the touch coordinate signals from the touch panel, determines whether the touch coordinate signals correspond to a display range of the icons, and executes, upon affirmative determination, an operating instruction corresponding to the determined icon.

Furthermore, to achieve the aforesaid objective of the invention, the present invention provides variant embodiments of a digital video record device with a touch-panel human machine interface.

The present invention is herein illustrated with preferred embodiments and drawings, so that one skilled in the pertinent art can gain insight into structures, features, other advantages and effects of the present invention from the disclosure of the invention.

### BRIEF DESCRIPTION OF THE DRAWINGS

The structure and the technical means adopted by the present invention to achieve the above and other objectives can be best understood by referring to the following detailed description of the preferred embodiments and the accompanying drawings, wherein:

FIG. 1 is a schematic view showing hardware architecture of a digital video record device with a touch-panel human machine interface according to the present invention;

FIG. 2 is a perspective view of the digital video record device with a touch-panel human machine interface according to the present invention;

FIG. 3 is a schematic view showing an output of the digital video record device to the screen of a monitor according to the present invention;

FIG. 4 is a flow chart showing control of the touch-panel human machine interface of the digital video record device according to the present invention;

FIGS. 5A and 5B are schematic views showing the screen in a variant embodiment of control of the touch-panel human machine interface of the digital video record device according to the present invention;

FIGS. 6A and 6B are schematic views showing the screen in another variant embodiment of control of the touch-panel human machine interface of the digital video record device according to the present invention;

FIG. 7 is a schematic view showing the screen in yet another variant embodiment of control of the touch-panel human machine interface of the digital video record device according to the present invention; and

FIGS. 8A and 8B are schematic views showing the screen in still yet another variant embodiment of control of the touch-panel human machine interface of the digital video record device according to the present invention.

### DETAILED DESCRIPTION OF THE INVENTION

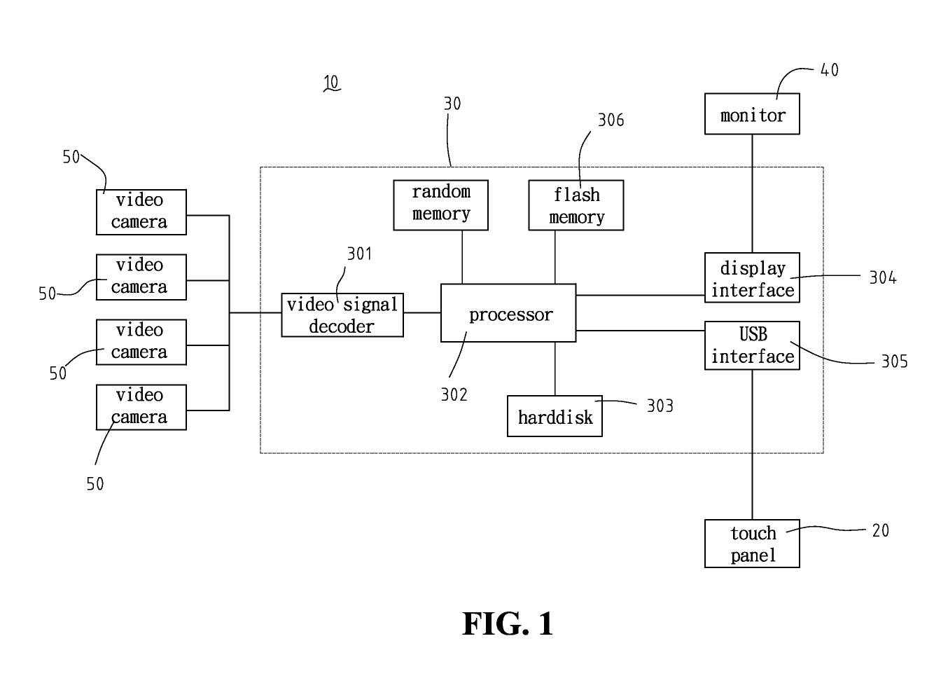

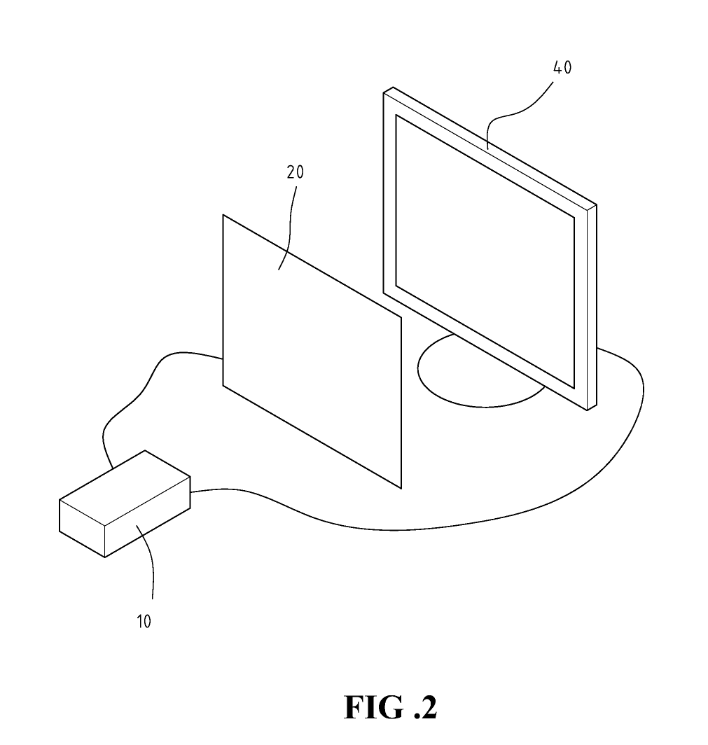

FIG. 1 is a schematic view showing hardware architecture of a digital video record device with a touch-panel human machine interface according to the present invention. FIG. 2 is a perspective view of the digital video record device with a touch-panel human machine interface according to the present invention. Referring to the above drawings, a digital video record device 10 with a touch-panel human machine interface comprises a touch panel 20 and a digital video record electronic apparatus 30. To start using the digital video record device 10, a monitor 40 (for example, a liquid crystal monitor) is connected to the digital video record device 10, and at least one video camera 50 is connected to the digital video record device 10. The video cameras 50 record images at a monitored venue, generate video signals, and send the video signals to the digital video record electronic apparatus 30. The digital video record electronic apparatus 30 processes the video signals from the video cameras 50, and displays video signal related pictures on the monitor 40. For instance, the video signals from the video cameras 50 are displayed by multiple split windows (for example, four split windows).

Referring to FIG. 1, the input end of a video signal decoder 301 is connected to the video cameras 50 respectively, and the output end of the video signal decoder 301 is connected to a processor 302. The processor 302 can be a central processor unit (CPU) or a digital signal processor (DSP). The video signals from the video cameras 50 are processed by the video signal decoder 301 first. The processor 302 controls the operation of the video signal decoder 301, for example, storing the video signals processed by the video signal decoder 301 in a hard disk 303, or outputting the video signals processed by the video signal decoder 301 to the monitor 40 via a display interface 304. One end of a USB interface 305 is connected to the touch panel 20, and the other end of the USB interface 305 is connected to the processor 302. With a touch of a user's finger on the touch panel 20, the touch panel 20 generates touch coordinate signals instantly. Then, the touch coordinate signals are sent to the processor 302 via the USB interface 305. The USB interface 305 is replaceable with a RS-232 interface or any other interfaces. As shown in FIG. 1, all of the constituent hardware components of the digital video record device 10 are replaceable with conventional electronic components.

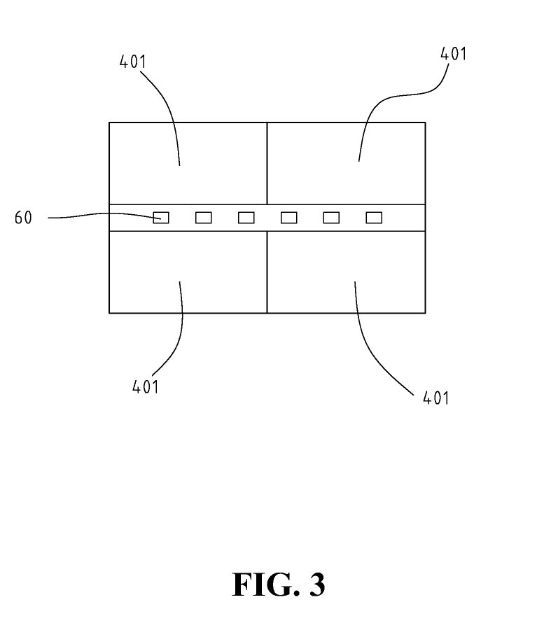

FIG. 3 is a schematic view showing an output of the digital video record device to the screen of a monitor according to the present invention. The screen of a monitor 40 is split up into a plurality of windows 401 (for example, four windows). Each of the windows 401 displays images recorded in real-time by a corresponding one of the video cameras 50. The junction of the upper ones of the windows 401 and the lower ones of the windows 401 functions as a display region for icons 60. The icons 60 denote operating instructions, such as operation instructions to record, play, pause, stop, print, etc.

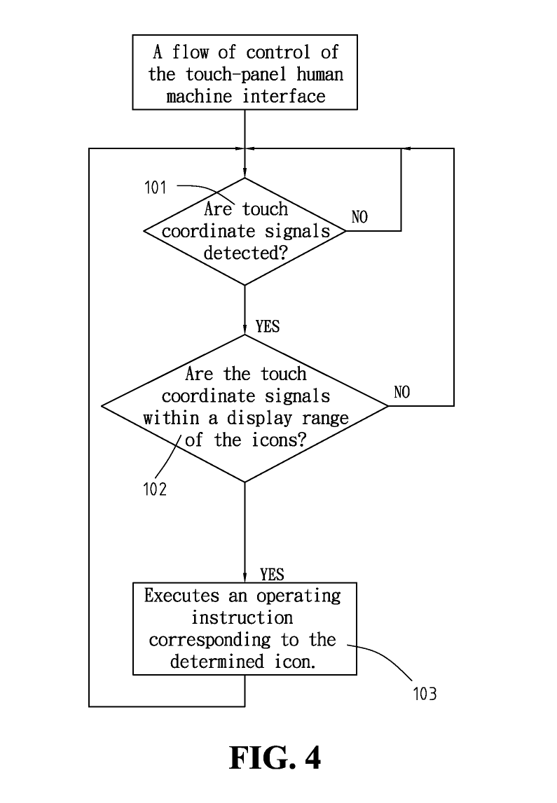

FIG. 4 is a flow chart showing control of the touch-panel human machine interface of the digital video record device according to the present invention. In step 101, the processor 302 detects whether the touch coordinate signals are received from the touch panel 20, and goes to step 102 upon detection of receipt of the touch coordinate signals, otherwise proceeds with the detection. In step 102, the processor 302 determines whether the touch coordinate signals correspond to a display range of the icons 60, and, upon affirmative determination, goes to step 103, and the digital video record electronic apparatus 30 executes an operating instruction corresponding to the determined icon 60, otherwise goes back to step 101. For instance, upon determination that the touch coordinate signals are within the display range of the record icon 60, the processor 302 executes an operating instruction of video record. Also, for instance, upon determination that the touch coordinate signals are within the display range of the play icon 60, the processor 302 executes an operating instruction to play video.

The program codes of the control process of the touch-panel human machine interface, data about the icons 60, and the program codes of the corresponding operating instructions are stored in a flash memory 306.

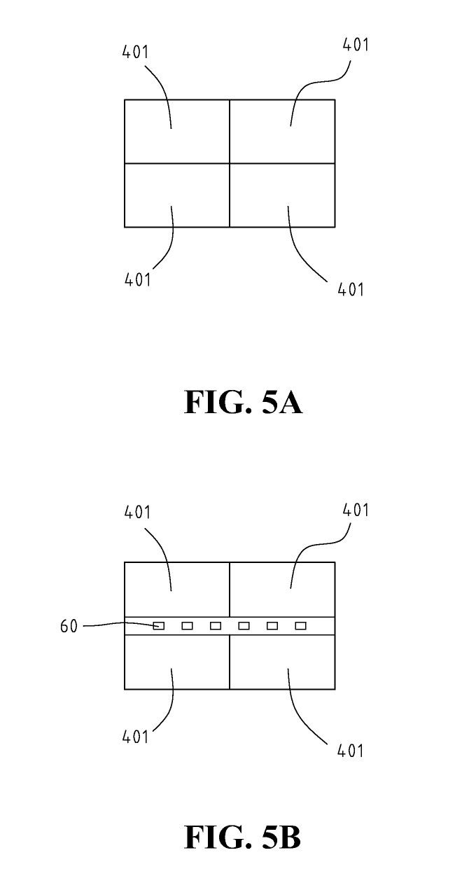

In the above embodiment, during most of the operating period, the icons 60 are displayed at the junction of the upper ones of the windows 401 and the lower ones of the windows 401. However, considering the actual usage of the digital video record device 10, so short is the duration in which a user uses the icons 60 to give operating instructions. Hence, to be efficient, the icons 60 will be displayed only when a user really wants to use the icons 60. FIGS. 5A and 5B are schematic views showing the screen in a variant embodiment of control of the touch-panel human machine interface of the digital video record device according to the present invention. Referring to FIG. 5A, during most of the operating period of time, the multiple windows 401 (for example, four windows) on the screen of the monitor 40 display images recorded in real-time by the video cameras 50, without displaying the icons 60. Where the user really wants to use the icons 60, the user may access the junction of the upper ones of the windows 401 and the lower ones of the windows 401 so as to make the touch panel 20 generate touch coordinate signals, and then the processor 302 displays a plurality of the icons 60 denoting operating instructions at the junction of the upper ones of the windows 401 and the lower ones of the windows 401 of the monitor 40, as shown in FIG. 5B. Afterward, the processor 302 receives the touch coordinate signals from the touch panel 20, determines whether the touch coordinate signals correspond to the display range of the icons 60, and executes, upon affirmative determination, an operating instruction corresponding to the determined icon 60.

In the above variant embodiment, the processor 302 stops the displaying of a plurality of icons 60 and restores an original picture on the monitor 40, or, in other words, restoring the screen of the monitor 40 shown in FIG. 5A, whenever the processor 302 has not received the touch coordinate signals from the touch panel 20 again for a predetermined period of time (for example, 30 seconds) after the processor 302 displayed the icons 60 on the monitor 40.

In the present invention, the icons 60 are displayed at the junction of the upper ones of the windows 401 and the lower ones of the windows 401, such that the monitoring screen of the windows remain unaffected and free of damage. However, the position at which the icons 60 are displayed is not limited to the aforesaid junction, but can take place elsewhere.

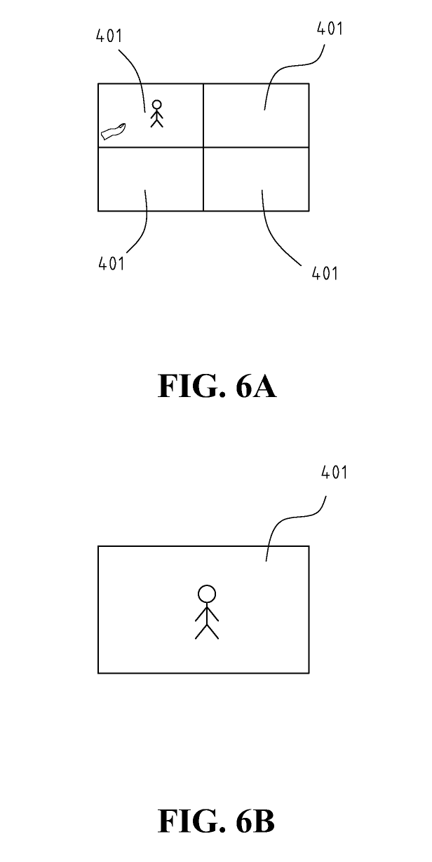

FIGS. 6A and 6B are schematic views showing the screen in another variant embodiment of control of the touch-panel human machine interface of the digital video record device according to the present invention. Referring to FIG. 6A, in general, the plurality of windows 401 (for example, four windows) on the screen of the monitor 40 display images recorded in real-time by the video cameras 50. Where the user wants to watch the monitoring screen of one of the windows 401 more clearly, the user may touch the touch panel 20 of the intended one of the windows 401, and then the processor 302 scales up the display range of the to-be-monitored one of the windows 401, for example, enlarging the to-be-monitored one of the windows 401 to provide full-screen display, as shown FIG. 6B. Conversely, where the user touches the touch panel 20 of the display-range-enlarged one of the windows 401, the processor 302 restores the display-range-enlarged one of the windows 401 to the original display range thereof, for example, restoring to the original four windows 401.

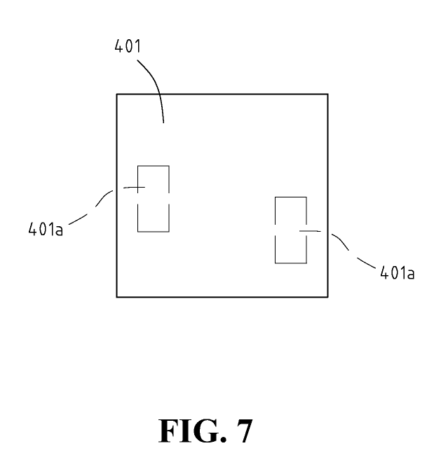

The aforesaid exemplary description of the windows 401 scaled up to enable full-screen display is further expounded hereunder. FIG. 7 is a schematic view showing the screen in yet another variant embodiment of control of the touch-panel human machine interface of the digital video record device according to the present invention. Where the user wants to define an image motion detection region 401a in the windows 401, the user may touch the touch panel 20 of the windows 401 so as to generate closed-region touch coordinate signals and define a region. The region defined is configured as the image motion detection region 401a; for instance, the windows 401 shown in FIG. 7 are defined with two said image motion detection regions 401a.

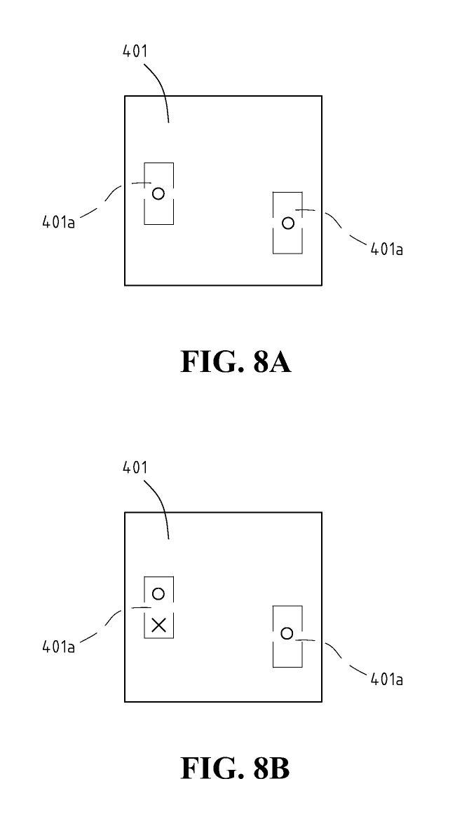

The aforesaid exemplary description of the windows 401 with the image motion detection region 401a is further expounded hereunder. FIGS. 8A and 8B are schematic views showing the screen in still yet another variant embodiment of control of the touch-panel human machine interface of the digital video record device according to the present invention. Referring to FIG. 8A, the processor 302 executes image motion detection related program codes on the image motion detection region 401a all the time, and once the processor 302 detects image motion or change in the image motion detection region 401a (see change X in FIG. 8B), the processor 302 will execute an operating instruction, such as an operating instruction of video record, an operating instruction to output an alert message, and an operating instruction of high definition video record, on the picture with detected image motion or change.

The monitor 40 and the touch panel 20 can be integrated with one another to form a one-piece device. In addition, the monitor 40, the touch panel 20, and the digital video record electronic apparatus 30 can be further integrated with one another to form a one-piece device.

According to the present invention, a digital video record device with a touch-panel human machine interface has the following advantages: issuing an operating instruction by means of touch coordinate signals from a touch panel, and displaying an icon denoting the operating instruction on the monitor to facilitate operation of issuing the operating instruction.

The foregoing description of the preferred embodiments is only illustrative in order to disclose the features and functions of the present invention, but is not restrictive of the scope of the present invention. Persons skilled in the art should understand that any equivalent modifications and variations made according to the spirit and principle of the disclosure of the present invention and described in the specification and drawings should fall within the scope of the appended claims.

What is claimed is:

1. A digital video record device with a touch-panel human machine interface, comprising:
a touch panel disposed in front of a screen of a monitor, electrically connected to a digital video record electronic apparatus, configured to generate touch coordinate signals, and adapted to send the touch coordinate signals to the digital video record electronic apparatus; and
the digital video record electronic apparatus for electrically connecting with at least a video camera, processing video signals generated by the video cameras, displaying video signal related pictures and a plurality of icons denoting operating instructions on the monitor, receiving the touch coordinate signals from the touch panel, determining whether the touch coordinate signals correspond to a display range of the icons, and executing, upon affirmative determination, an operating instruction corresponding to the determined icon.

2. The digital video record device of claim 1, wherein the icons are displayed at a junction of split windows on the screen of the monitor.

3. The digital video record device of claim 1, wherein the icons are displayed at any display region of the monitor.

4. The digital video record device of claim 1, wherein the monitor is a liquid crystal monitor.

5. The digital video record device of claim 1, wherein the monitor and the touch panel are integrated with one another to form a one-piece device.

6. The digital video record device of claim 1, wherein the touch panel, the digital video record electronic apparatus, and the monitor are integrated with one another to form a one-piece device.

7. A digital video record device with a touch-panel human machine interface, comprising:
a touch panel disposed in front of a screen of a monitor, electrically connected to a digital video record electronic apparatus, configured to generate touch coordinate signals, and adapted to send the touch coordinate signals to the digital video record electronic apparatus;
the digital video record electronic apparatus for electrically connecting with at least a video camera, processing video signals generated by the video cameras, displaying video signal related pictures on the monitor in real-time, receiving the touch coordinate signals from the touch panel, determining whether the touch coordinate signals are within a predetermined region of the monitor, displaying, upon affirmative determination, a plurality of icons denoting operating instructions on the monitor, receiving again the touch coordinate signals from the touch panel, determining whether the touch coordinate signals correspond to a display range of the icons, and executing, upon affirmative determination, an operating instruction corresponding to the determined icon.

8. The digital video record device of claim 7, wherein the predetermined region is located at a junction of split window screens of the monitor.

9. The digital video record device of claim 8, wherein the icons are displayed at a junction of split window screens of the monitor.

10. The digital video record device of claim 7, wherein the predetermined region is any display region of the monitor.

11. The digital video record device of claim 7, wherein the digital video record device stops the displaying of the icons and restores an original picture on the monitor whenever the digital video record device has not received the touch coordinate signals from the touch panel again for a predetermined period of time after the digital video record electronic apparatus displayed a plurality of icons denoting an operating instruction on the monitor.

12. The digital video record device of claim 7, wherein the monitor is a liquid crystal monitor.

13. The digital video record device of claim 7, wherein the monitor and the touch panel are integrated with one another to form a one-piece device.

14. The digital video record device of claim 7, wherein the touch panel, the digital video record electronic apparatus, and the monitor are integrated with one another to form a one-piece device.

15. A digital video record device with a touch-panel human machine interface, comprising:
a touch panel disposed in front of a screen of a monitor, electrically connected to a digital video record electronic apparatus, configured to generate touch coordinate signals, and adapted to send the touch coordinate signals to the digital video record electronic apparatus;
the digital video record electronic apparatus for electrically connecting with at least a video camera, processing video signals generated by the video cameras, displaying video signal related pictures on the monitor, receiving the touch coordinate signals from the touch panel, determining which one of the video cameras is attributed to a corresponding one of the video signal related pictures having a display range matching the touch coordinate signals, and executing an operating instruction on the determined picture only.

16. The digital video record device of claim 15, wherein the monitor is a liquid crystal monitor.

17. The digital video record device of claim 15, wherein the monitor and the touch panel are integrated with one another to form a one-piece device.

18. The digital video record device of claims 15, wherein the touch panel, the digital video record electronic apparatus, and the monitor are integrated with one another to form a one-piece device.

19. The digital video record device of claim 15, wherein the operating instruction is one selected from the group consisting of an operating instruction to scale up a window display range, an operating instruction to scale down a window display range, an operating instruction to restore an original window display range, and an operating instruction to define an image motion detection region.

20. A digital video record device with a touch-panel human machine interface, comprising:
a touch panel disposed in front of a screen of a monitor, electrically connected to a digital video record electronic apparatus, configured to generate touch coordinate signals, and adapted to send the touch coordinate signals to the digital video record electronic apparatus;
the digital video record electronic apparatus for electrically connecting with at least a video camera, processing video signals generated by the video cameras, displaying video signal related pictures on the monitor, setting sub-regions in the pictures to an image motion detection region, and executing, upon detection of image motion and/or change by the image motion detection region, an operating instruction on only the pictures with detected image motion and/or change.

21. The digital video record device of claim 20, wherein the monitor is a liquid crystal monitor.

22. The digital video record device of claim 20, wherein the monitor and the touch panel are integrated with one another to form a one-piece device.

23. The digital video record device of claim 20, wherein the touch panel, the digital video record electronic apparatus, and the monitor are integrated with one another to form a one-piece device.

24. The digital video record device of claim 20, wherein the operating instruction is one selected from the group consisting of an operating instruction of video record, an operating instruction to output an alert message, and an operating instruction of high definition video record.
